(19) United States
(12) Patent Application Publication
(10) Pub. No.: US 2016/0376000 A1
(43) Pub. Date: Dec. 29, 2016

(54) SUBMERSIBLE UNMANNED AERIAL VEHICLES AND ASSOCIATED SYSTEMS AND METHODS

(71) Applicant: Christoph Kohstall, Los Altos, CA (US)

(72) Inventor: Christoph Kohstall, Los Altos, CA (US)

(21) Appl. No.: 14/788,549

(22) Filed: Jun. 30, 2015

Related U.S. Application Data
(60) Provisional application No. 62/023,145, filed on Jul. 10, 2014.

(51) Int. Cl. B64C 37/00; B64C 27/08; B63G 8/08; B64C 39/02; B60F 5/02; B63G 8/00

(52) U.S. Cl. CPC B64C 37/00; B60F 5/02; B63G 8/001; B63G 8/08; B64C 39/024; B64C 27/08; B63G 2008/004; B63G 2008/005; B64C 2201/18; B64C 2201/108; B64C 2201/141; B64C 2201/146

(57) ABSTRACT

Submersible unmanned aerial vehicles (UAVs) and associated systems and methods are disclosed. A representative submersible UAV includes a support structure, a power source carried by the support structure, and a plurality of propellers carried by the support structure and coupled to the power source. The propellers can include a plurality of first laterally spaced-apart propellers positioned above a plurality of second laterally spaced-apart propellers along an axis extending upwardly from the support structure.

### CROSS-REFERENCE TO RELATED APPLICATION

The present application claims priority to U.S. Provisional Application No. 62/023,145, filed on Jul. 10, 2014 and incorporated herein by reference.

### TECHNICAL FIELD

The present technology is directed generally to submersible unmanned aerial vehicles, and associated systems and methods.

### BACKGROUND

Unmanned vehicles have become increasingly popular for consumers, law enforcement, research, and other tasks. They facilitates a wide variety of applications, including, for example, hostage rescue, crash recovery, sports monitoring, environmental monitoring and surveillance, among others. Unfortunately, the capabilities of most UAVs are limited to only a handful of maneuvers. In particular, most UAVs are able to operate only from land or other hard surfaces. Although some existing UAV designs are intended for operation in both air and water, a drawback with such designs is that they can be complex and/or difficult or non-intuitive to operate. Accordingly, there remains a need in the industry for submersible UAVs that are low cost, simple to manufacture, and/or simple to operate.

### BRIEF DESCRIPTION OF THE DRAWINGS

FIG. 1 is a partially schematic illustration of a representative submersible UAV configured to operate in the air and underwater, in accordance with an embodiment of the present technology.

FIG. 2 is a partially schematic, isometric illustration of components of the representative UAV shown in FIG. 1.

FIG. 3 is a partially schematic illustration of a process sequence for submerging an airborne UAV in accordance with an embodiment of the present technology.

FIG. 4 is a flow diagram illustrating particular processes associated with the sequence described with reference to FIG. 3.

FIG. 5 is a partially schematic illustration of a process sequence for directing a submersible UAV from the water into the air, in accordance with an embodiment of the present technology.

FIG. 6 is a flow diagram illustrating particular processes associated with the sequence described with reference to FIG. 5.

FIG. 7 is a partially schematic, isometric illustration of a submersible UAV configured to transmit and receive information at radio frequencies and hydroacoustic frequencies in accordance with an embodiment of the present technology.

FIG. 8A is a partially schematic illustration of a relay buoy configured to transmit and receive information at radio frequencies and hydroacoustic frequencies in accordance with an embodiment of the present technology.

FIG. 8B is a partially schematic illustration of a process sequence for unloading and retrieving a relay buoy in accordance with an embodiment of the present technology.

FIG. 9A is a partially schematic illustration of a UAV having a fuselage configured to submerge four propellers upon landing in the water, in accordance with an embodiment of the present technology.

FIG. 9B is a partially schematic illustration of a submersible UAV having a fuselage configured to support a camera in accordance with another embodiment of the present technology.

FIG. 9C is a partially schematic illustration of a prototype submersible UAV configured in accordance with an embodiment of the present technology.

FIG. 10 is a partially schematic illustration of a user controller configured in accordance with an embodiment of the present technology.

FIG. 11 is a partially schematic illustration of a UAV, controller, and corresponding coordinate systems oriented in accordance with an embodiment of the present technology.

FIG. 12 schematically illustrates representative UAV maneuvers and associated relative thrusts for each of multiple propellers in accordance with an embodiment of the present technology.

FIG. 13 illustrates schematically components of a user controller and an on-board UAV flight controller configured in accordance with embodiments of the present technology.

FIG. 14 is a schematic illustration of a user controller, relay buoy, and on-board UAV flight controller configured in accordance with embodiments of the present technology.

FIG. 15 is a partially schematic illustration of a single-axis feedback control loop configured to be carried out by a UAV microcontroller in accordance with an embodiment of the present technology.

FIG. 16 is a partially schematic illustration of a multi-axis feedback control loop arrangement configured to be carried out by a UAV microcontroller in accordance with another embodiment of the present technology.

FIG. 17 is a partially schematic illustration of a process for submerging a UAV in accordance with an embodiment of the present technology.

FIG. 18 is a partially schematic illustration of a process for directing a submerged UAV from the water into the air, in accordance with an embodiment of the present technology.

FIG. 19 is a block diagram illustrating components of a representative computer system configured in accordance with an embodiment of the present technology.

The headings provided herein are for convenience only and do not necessarily affect the scope or meaning of the claimed embodiments. Further, the drawings have not necessarily been drawn to scale. For example, the dimensions of some of the elements in the Figures may be expanded or reduced to help improve the understanding of the embodiments. Similarly, some components and/or operations may be separated into different blocks or combined into a single block for the purposes of discussion of some of the embodiments. Moreover, while the various embodiments are amenable to various modifications and alternative forms, specific embodiments have been shown by way of example in the Figures and are described in detail below.

### DETAILED DESCRIPTION

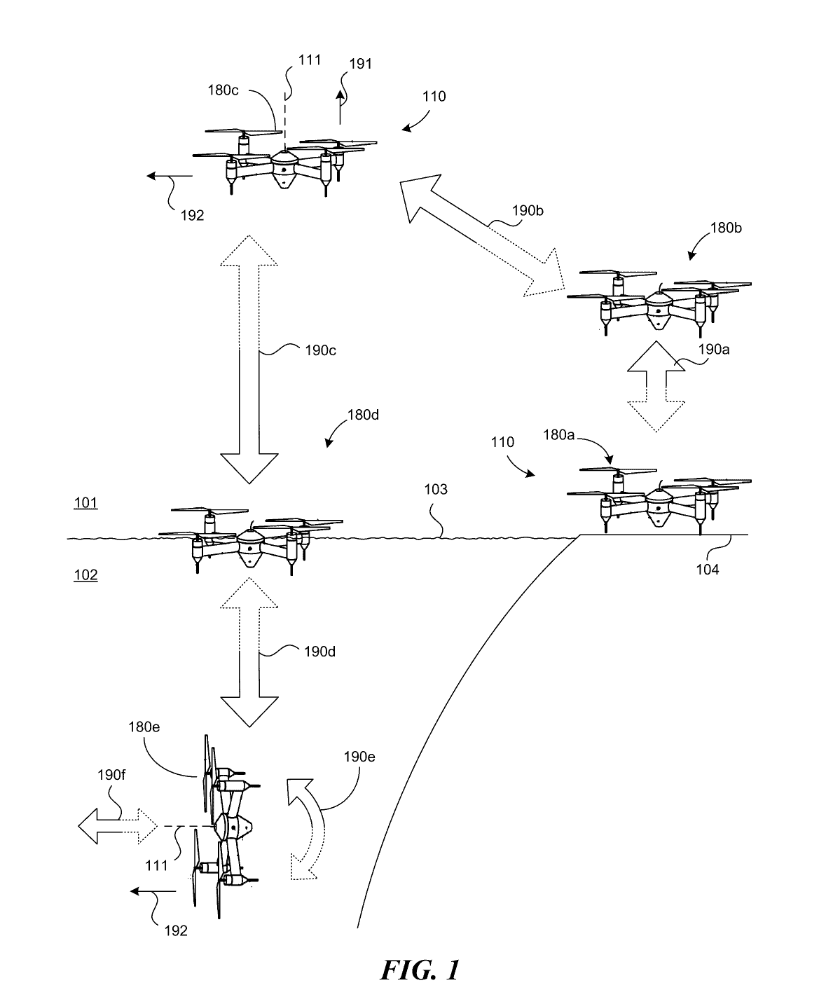

The presently disclosed technologies are directed generally to submersible unmanned aerial vehicles (UAVs) and associated systems and methods. The methods include methods of use, methods of instructing or directing use, and methods of manufacture. Specific embodiments are described below in the context of corresponding representative figures. Several details describing structures or processes that are well-known and often associated with UAVs, but that may unnecessarily obscure some significant aspects of the present technology, are not set forth in the following description for purposes of clarity. Moreover, although the following disclosure sets forth several embodiments of different aspects of the disclosed technology, several other embodiments of the technology can have different configurations or different components than those described in this section. As such, the disclosed technology may have other embodiments with additional elements, and/or without several of the elements described below with reference to FIGS. 1-19.

Many embodiments of the present disclosure described below may take the form of computer- or controller-executable instructions, including routines executed by a programmable computer or controller. Those skilled in the relevant art will appreciate that the disclosure can be practiced on computer systems other than those shown and described below. The technology can be embodied in a special purpose computer or data processor that is specifically programmed, configured or constructed to perform one or more of the computer-executable instructions described below. Accordingly, the terms “computer” and “controller” as generally used herein refer to any suitable data processor and can include Internet appliances and handheld devices, including palmtop computers, wearable computers, cellular or mobile phones, multi-processor systems, processor-based or programmable consumer electronics, network computers, mini-computers and the like. Information handled by these computers and/or controllers can be presented to a user, observer, or other participant via any suitable display medium, such as an LCD screen.

In particular embodiments, aspects of the present technology can be practiced in distributed environments, where tasks or modules are performed by remote processing devices that are linked through a communications network. In distributed computing environments, program modules or subroutines may be located in local and remote memory storage devices. Aspects of the technology described below may be stored or distributed on computer-readable media, including magnetically or optically readable or removable computer disks, as well as distributed electronically over networks. Data structures and transmissions of data particular to aspects of the present technology are also encompassed within the scope of particular embodiments of the present technology.

### 1. Overview

The present technology is directed generally to submersible UAVs. As used herein, the term “submersible UAV” refers generally to a UAV that can operate both in the air and underwater. In particular embodiments, the submersible UAV can use the same propulsion system to operate both in the air and underwater. For example, the UAV can have a quadcopter configuration and can operate as a typical quadcopter does while in the air. When underwater, the UAV can rotate 90 degrees so that the axial thrust provided by the propellers move it in a transverse direction. However, the general control logic for directing the UAV need not be switched to a different mode for underwater operation. In particular embodiments, the relative positions of paired sets of propellers can be offset so as to improve the ability of the UAV to both submerge for underwater operation, and emerge for aerial operation.

### 2. Representative Configurations

FIG. 1 is a partially schematic illustration of a representative UAV 110 as it takes off from land 104, flies through the air 101, and submerges into the water 102 for underwater operation. Representative UAV positions 180 (shown as positions 180a-180e) and representative motion vectors 190 (shown as vectors 190a-190f) are used to describe the sequence of locations and motions the UAV 110 undergoes as it moves from land to air to water. These motions may be reversed (as indicated by portions of the vectors 190 in dotted lines) to direct the UAV 110 from the water to the air and back to land.

In the sequence shown in FIG. 1, the UAV 110 begins on land 104 or another fixed or movable platform with aerial access, and ascends vertically as indicated by a land-based ascent/descent vector 190a. As the UAV 110 ascends, it can assume an ascent position 180b, and can be operated generally in the manner as existing quadrotor UAVs. The UAV 110 can then be directed along a flight path vector 190b so as to assume an in-flight position 180c. In the in-flight position, a vehicle axis 111 (generally parallel to the rotation axes of the propellers that lift the UAV 110) extends in a generally upward direction 191. For purposes of comparison, FIG. 1 also illustrates a generally transverse direction 192. As used herein, the generally upward direction 191 has a greater upward component than a transverse component, and the generally transverse direction 192 has a greater transverse component than an upward component.

Once over the water 102, the UAV 110 can follow a water-based descent/ascent vector 190c so as to land on the surface 103 of the water 102, as shown by a representative surface position 180d. From the surface 103, the UAV 110 follows a submerge/emerge vector 190d so as to be completely submerged under the surface 103. Once under the surface 103, the UAV 110 can rotate, as indicated by a rotation vector 190e so that the vehicle axis 111 is aligned in a generally transverse direction 192 rather than the generally upward direction 191. The UAV 110 can then be operated to follow an underwater path vector 190f, during which it performs underwater tasks or missions.

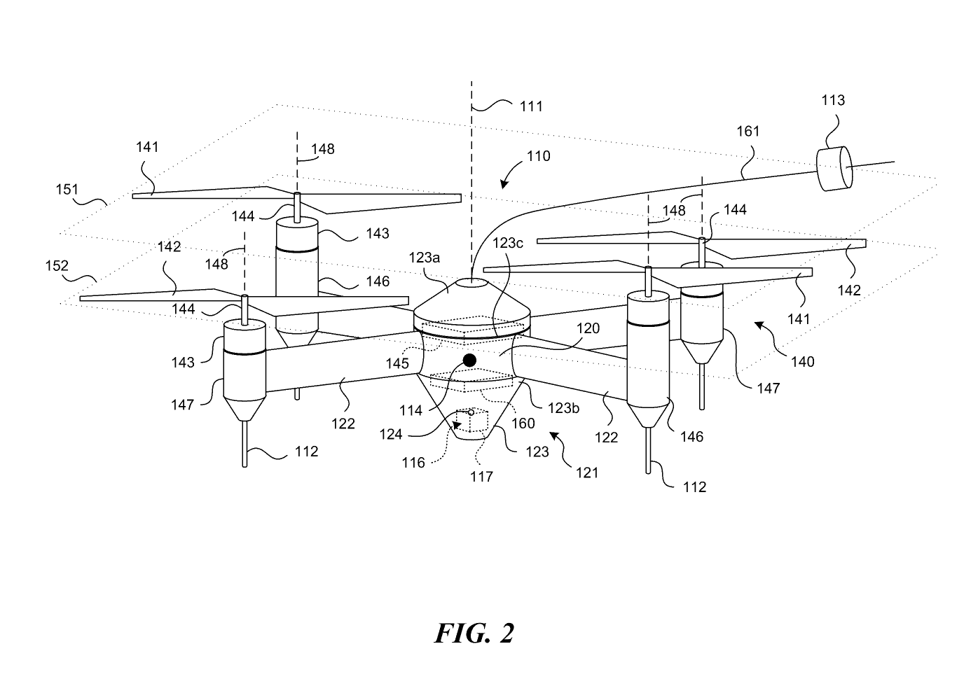

FIG. 2 is an enlarged, partially schematic illustration of the representative UAV 110 described above with reference to FIG. 1. The UAV 110 can include a support structure 120 suitable for both aerial flight and submerged operation. Accordingly, the support structure can tolerate extended exposure to water (fresh or saltwater) and at least parts of the support structure 120 are water-tight. The support structure 120 can be formed from polycarbonate, carbon fiber, and/or another suitable (e.g., water-tolerant, impact-resistant) material, and includes a central portion 121 and multiple, outwardly-extending boom portions 122. The central portion 121 can include a fuselage 123 that houses several components for operating the UAV and/or carrying out the mission of the UAV. For example, the fuselage 123 can house a power source 145 (e.g., a rechargeable battery), a controller 160 (e.g. suitable for controlling the aerial and submerged motion of the UAV 110), a payload 116 (e.g., a camera 117 aligned with a view port 124), and one or more sensors 114. The sensor(s) 114 can, among other functions, indicate whether the UAV 110 is in the air or the water. In a particular embodiment, the fuselage 123 can have a two-part construction, and can accordingly include an upper portion 123a that is threadably or otherwise releasably connected to a lower portion 123b at a joint 123c. Each portion 123a, 123b can be water tight, and the fuselage 123 can include an O-ring or other suitable structure for releasably securing the two portions together in a manner that withstands the external hydrostatic and hydrodynamic pressures to which the UAV 110 is subjected when it is submerged.

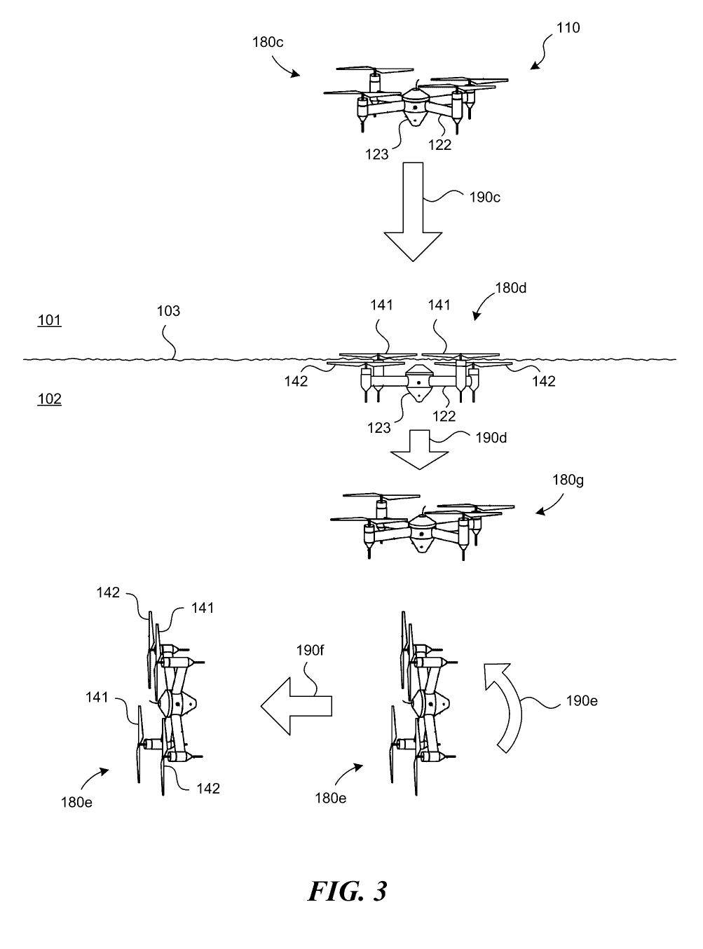

The UAV 110 also includes a propulsion system 140 that in turn can include multiple motor-driven propellers. The propellers are shown in FIG. 2 as first propellers 141 and second propellers 142. Each propeller 141, 142 can be driven by a corresponding motor 143 via a corresponding shaft 144 so as to rotate about a corresponding rotation axis 148, which can be generally aligned with the vehicle axis 111. Unlike at least some conventional arrangements, the shafts 144 can have fixed positions relative to each other (while still being rotatable about their individual rotation axes). This arrangement is accordingly simpler and less costly to manufacture, maintain, and operate than designs that require the motors and/or motor shafts to change position. In particular embodiments, the motors 143 include brushless motors, coreless motors, or induction motors. As described later with reference to FIG. 3, it may be desirable to reverse the rotation direction of the motors 143, so the particular motor (and/or its controller) can be selected to allow efficient rotation in two directions. In addition, the rotation rate of the propellers 141, 142 can vary significantly, particularly between aerial operation (for which the rotation rate is relatively high) and underwater operation (for which the rotation rate is relatively low). Accordingly, the motors 143 can also be selected to provide a wide range of rotation speeds. While a transmission system (e.g., a mechanical transmission system) can be used to provide this function, an induction motor can provide the function typically with less weight and/or complexity.

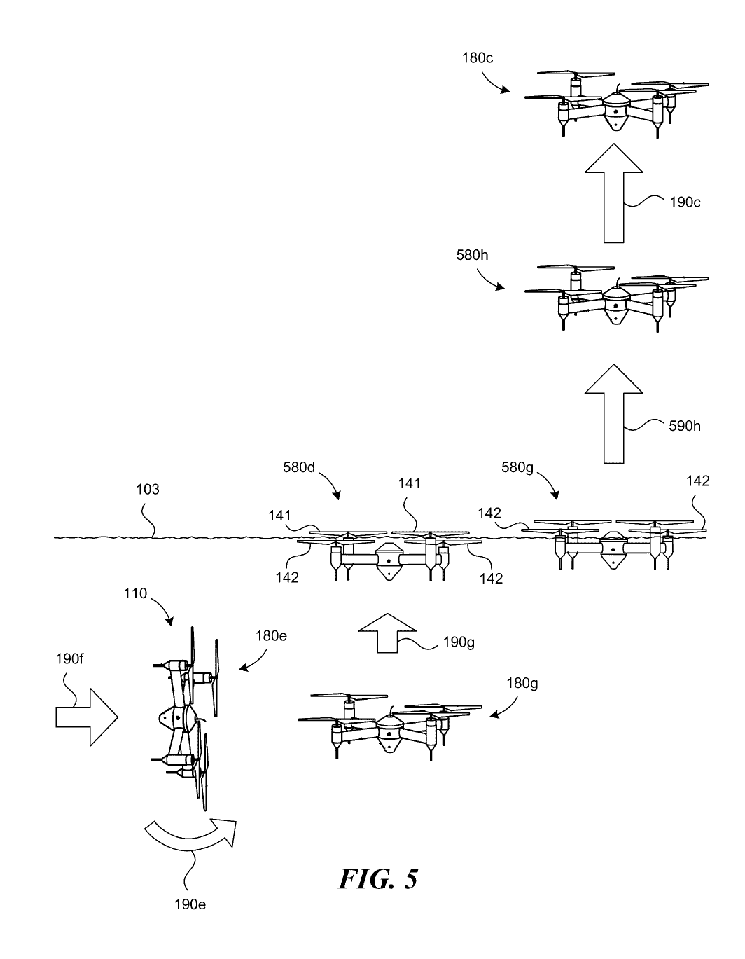

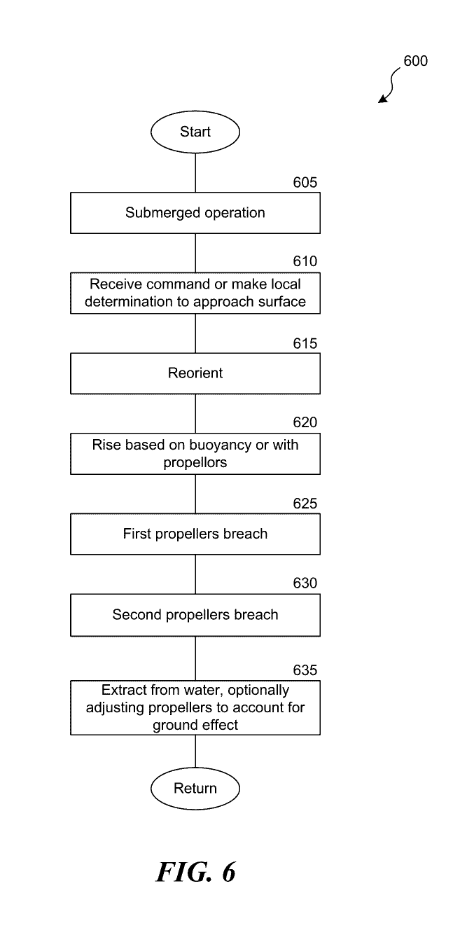

The motors 143 are carried by the boom portions 122 via corresponding motor supports, shown as first motor supports 146 for the first propellers 141 and second motor supports 147 for the second propellers 142. The first motor supports 146 shown in FIG. 2 are longer than the second motor supports 147. Accordingly, the first propellers 141 are positioned in a first surface (e.g., plane) 151, and the second propellers 142 are positioned in a second surface (e.g., plane) 152. The first plane 151 can be positioned further along the vehicle axis 111 than the second plane 152 so that, during normal ascent and descent, the first propellers 141 are positioned above the second propellers 142. As will be discussed later with reference to FIGS. 5 and 6, offsetting the first and second propellers 141, 142 along the vehicle axis 111 can facilitate extracting the UAV 110 from the water. As is also shown in FIG. 2, each of the propellers 141, 142 can be offset or spaced apart laterally from the others (e.g., so that none are in the prop wash of another). In other embodiments, the number of propellers can be doubled, with each propeller forming part of a stacked propeller pair, and with each member of the pair counter-rotating relative to the other. In this arrangement, the lower member of the pair is in the prop wash of the upper member, and each pair is offset from the prop wash footprint of the other pairs. An advantage of the paired propeller arrangement is that it can avoid yawing moments that may occur when the first propellers 141 are out of the water while the second propellers 142 are in the water. Conversely, an advantage of unpaired propellers is that the reduced number of propellers can be simpler and less costly to implement.

Other vehicle features shown in FIG. 2 include landing gear 112, which, in a particular embodiment, extend downwardly from the motor supports 146,147 to provide a multi-point structure for landing the UAV 110 on land or another solid surface. The landing gear 112 can include sensors that indicate landing on a hard surface (e.g., weight sensors) and/or sensors that indicate a water landing (e.g., water sensors). The UAV 110 can also include an antenna 161 configured to receive operation instructions from a user, and, optionally transmit information to the user. In a particular environment, the antenna 161 includes a floatation device 113 positioned to allow at least a portion of the antenna to project out of the water when the UAV is underwater. This arrangement can allow the user to maintain a radio-frequency (RF) communication link with the UAV 110, whether the UAV 110 is airborne or underwater. In a particular aspect of this embodiment, the antenna 161 can be flexible and can be carried by a reel (not shown in FIG. 2) housed in the fuselage 123. The antenna 161 can be reeled out to allow the UAV 110 to descend to suitable depths, and then reeled in to avoid interfering with the flight of the UAV when it is airborne. The antenna 161 may be flexible such that the floatation device 113 is always at the water's surface independent of the orientation of the UAV 110, but the flexibility of the antenna 161 may be constrained such that it cannot interfere with the propellers.

FIG. 3 is a partially schematic illustration of the UAV 110 illustrating, in greater detail, a representative submersion process sequence in accordance with an embodiment of the present technology. Beginning with the illustrated in-flight position 180c, the UAV 110 follows a decent vector 190c until it reaches the surface 103 of the water 102. In some embodiments, the UAV 110 is neutrally or negatively buoyant, and so begins submerging on its own. In other embodiments, the UAV 110 is initially positively buoyant and the UAV may submerge by reversing the spinning direction of the propellers and/or the UAV can take on water as ballast (e.g., in the fuselage 123 and/or the boom portions 122). The ballast is then dumped when the UAV 110 re-surfaces.

As the UAV 110 begins to submerge in the water 102, the second propellers 142 submerge before the first propellers 141 do. This arrangement can allow the first propellers 141 to remain exposed to the air 101, e.g., to help extract the UAV 110 in case the submerging process is aborted. In addition, the submerged second propellers 142 can expedite the submersion process. In particular, the second propellers 142 can direct the UAV 110 downwardly along the submersion vector 190d faster than the UAV 110 might otherwise descend on its own. Because the second propellers 142 are typically oriented to provide lift, the foregoing process typically includes adjusting the second propellers 142 to instead propel the UAV downwardly. One suitable approach is to reverse the rotation direction of the second propellers 142 (while the propellers maintain a fixed pitch angle) so that they force the UAV 110 downwardly rather than upwardly. Another approach is to reverse the pitch of the second propellers 142, without changing the rotation direction of the second propellers 142. An advantage of reversing the rotation direction is that it is typically simpler to implement and does not require a more complex variable pitch control mechanism for the propellers 142.

As the UAV 110 continues to descend, the first propellers 141 becomes submerged. They, too, can be configured to drive the UAV 110 to a deeper ascent/descent position 180g. The first and second propellers 141,142 are then selectively activated to roll the UAV 110, as indicated by rotation vector 190e so that the UAV 110 assumes the underwater travel position 180e. The propellers 141,142 are then typically reconfigured to provide lift (e.g. by re-reversing the motors and/or re-reversing the pitch of the propeller blades) to accomplish this maneuver. The propellers 142, 143 are then used to propel the UAV 110 along the underwater path vector 190f.

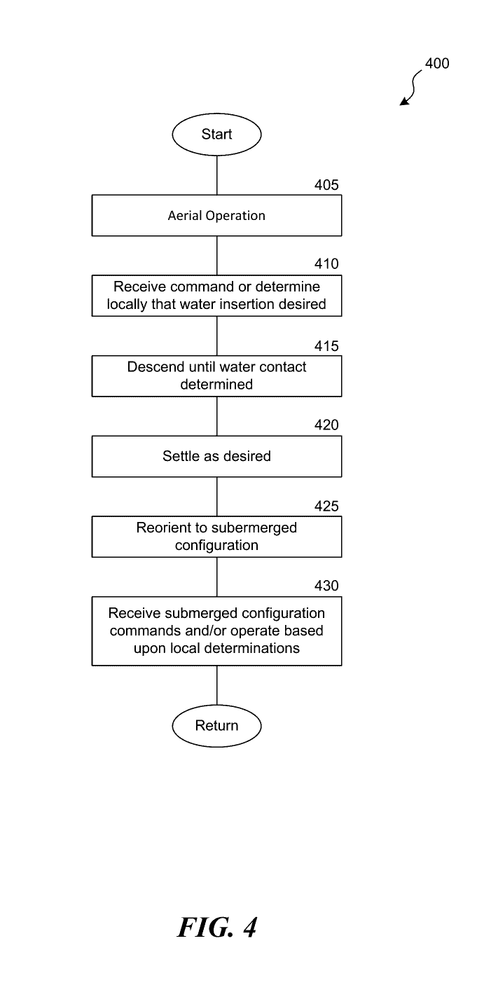

FIG. 4 is a flow diagram illustrating a process 400 for converting from aerial to submerged operations. Process portion 405 includes flying the UAV in the air. Process portion 410 includes receiving a command to submerge the UAV, or determining (e.g., autonomously) to insert the UAV into the water. In process 415, the UAV descends until it contacts the water. Any of a variety of suitable sensors (e.g., water, pressure or moisture sensors or a sensor measuring the rotation speed of the propellers) can be used to determine when the UAV contacts the water. In process portion 420, the UAV settles into the water. For example, the UAV can be neutrally buoyant and can accordingly settle just below the surface of the water. In other embodiments, the UAV can be positively buoyant, in which case, the propellers can be used to settle the UAV underwater, as described above with reference to FIG. 3. In still further embodiments, the UAV can be negatively buoyant and can accordingly settle under its own weight. In at least some embodiments, it is preferable to have the UAV be neutrally or positively buoyant. For example, if the UAV is neutrally buoyant, the propulsion force required to move it along a lateral trajectory once it has submerged is reduced because no propulsive force is needed to maintain the depth of the UAV. If the UAV is positively buoyant, some propulsive force is needed to keep the UAV underwater. However, this drawback may be outweighed by the ability of the UAV to rise to the surface without power, for example, if the on-board power source is depleted before the UAV returns to the surface under its own power.

Once the UAV has been submerged, it can reorient to the submerged travel position described above with reference to FIGS. 1 and 3 (process portion 425). Once in this configuration, the UAV receives submerged configuration commands and/or operates autonomously based on determinations made on-board the UAV (process portion 430).

FIG. 5 schematically illustrates further details of a process sequence for causing the UAV 110 to surface and fly after having been submerged. While underwater, the UAV 110 follows a transverse movement vector 190f and then re-orients, as indicated by arrow 190e, to assume an ascent/descent position 180g. The UAV 110 then follows an ascent vector 190g and reaches the surface 103. As the UAV 110 reaches the surface 103, the first propellers 141 break the surface before the second propellers 142 do. Accordingly, the UAV 110 assumes a first breach position 580d. Once in this position, the submerged second propellers 142 keep propelling the UAV 110 upwardly. In addition, the first propellers 141 are exposed to air and can speed up to create lift in the air and hence lift the UAV 110 further up. At this point, the UAV assumes a second breach position 580g with the first and second propellers 141, 142 above the surface 103. The second propellers 142 can now speed up and create lift in the air. The UAV 110 then begins an aerial ascent, initially while in ground effect, as indicated by vector 590h. While in ground effect, the UAV 110 has an initial aerial ascent position 580h. As the UAV 110 moves out of ground effect and follows the ascent trajectory 190c, it achieves an in-flight position 180c from which it can fly a suitable airborne mission. In one aspect of the foregoing embodiment, the shapes of the propellers 141, 142 may be optimized for aerial performance rather than underwater performance.

FIG. 6 illustrates a process 600 for surfacing the UAV 110 generally in the manner described above with reference to FIG. 5. Process portion 605 includes operating the submerged UAV, and process portion 610 includes receiving a command to surface the UAV, or autonomously (e.g., on-board the UAV) determining that the UAV should surface. In process portion 615, the UAV re-orients from the submerged, transverse-facing orientation to an upwardly-facing ascent orientation. In process portion 620, the UAV rises through the water column based on buoyancy and/or lift forces provided by the propellers. In process portion 625, the second propellers lift the UAV further such that the first propellers breach the surface and can act on the surrounding air to pull the UAV further up, causing the second propellers to breach the surface (process portion 630). In portion 635, the second propellers act on the surrounding air and the UAV ascends from the water. This process can include adjusting the propellers (e.g., the propeller speed) as the UAV moves out of ground effect, described above.

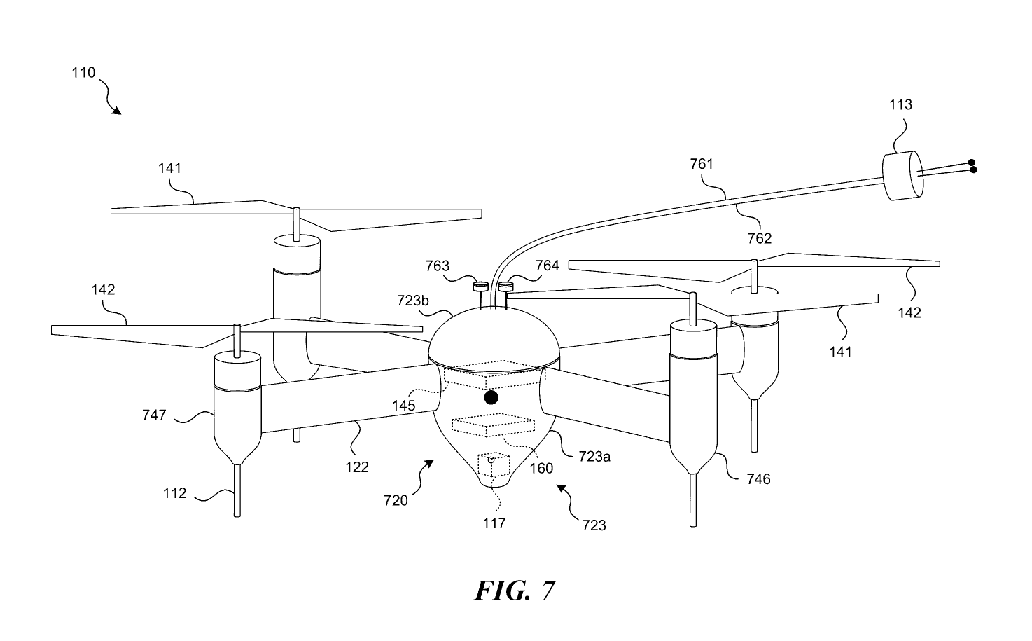

FIG. 7 is a partially schematic, isometric illustration of a UAV 110 having several features that differ from those of the configuration described above with reference to FIG. 2. In particular, the UAV 110 can include a support structure 720 having a fuselage 723 shaped for improved aerodynamic and/or hydrodynamic performance. For example, the lower portion 723a of the fuselage 723 can have a curved, tapered shape that facilitates descent through the water column. The corresponding upper portion 723b of the fuselage 723 can have a rounded shape for improved aerodynamic and/or hydrodynamic performance and that facilitates ascent through the water column. The corresponding first and second motor supports 746, 747 can also be tapered for improved aerodynamic and/or hydrodynamic performance. Tapers on the upward portions of the motor supports 746, 747 can increase the aerodynamic and/or hydrodynamic performance even further.

The UAV 110 can also include features for facilitating one-way and, optionally, two-way communication, both while in the air and while underwater. For example, the UAV 110 can include both an aerial receiver antenna 761 (for receiving commands) and an aerial transmitter antenna 762 (e.g. for transmitting diagnostic information and/or other data, including photos and/or video data). For example, the aerial transmitter antenna 762 can be used to provide real-time or near real-time data from the onboard camera 117, which can facilitate the operation of the UAV 110 (by providing a view of the surrounding area) and/or facilitate processing the data obtained from the UAV 110 (e.g., by allowing the operator to quickly move the UAV to particular areas of interest). The UAV 110 can also include a similar communication arrangement for underwater operation. In particular, the UAV 110 can include an underwater receiver antenna 763 and, optionally, an underwater transmitter antenna 764. Unlike the aerial receiver antennas 761, 762 the underwater antennas 763, 764 can operate at hydroacoustic frequencies rather than radio frequencies. Hydroacoustic frequencies can include sonar frequencies, subsonic frequencies, and/or ultrasonic frequencies. Any of the foregoing frequencies can be selected to provide more effective communication underwater than is available via radio frequencies.

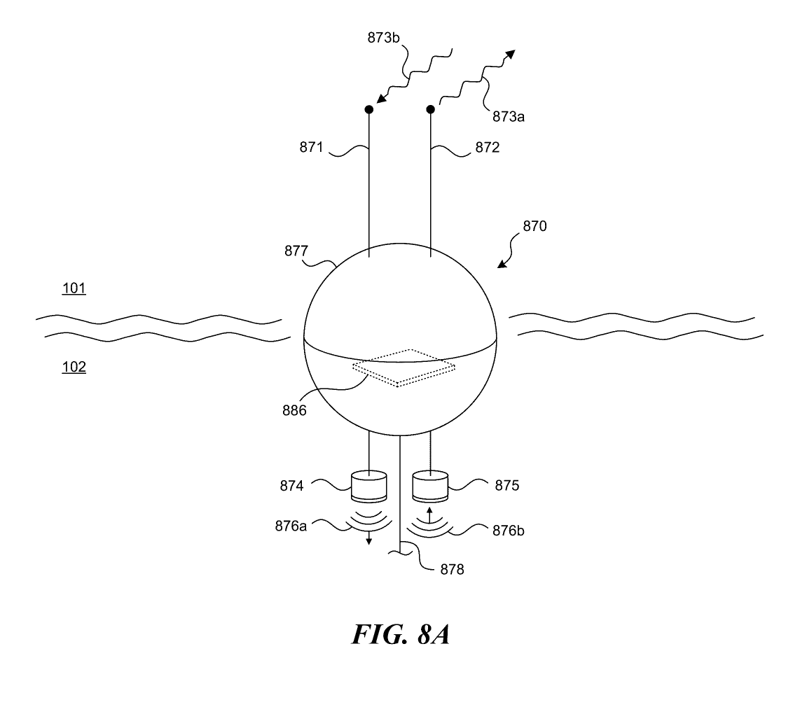

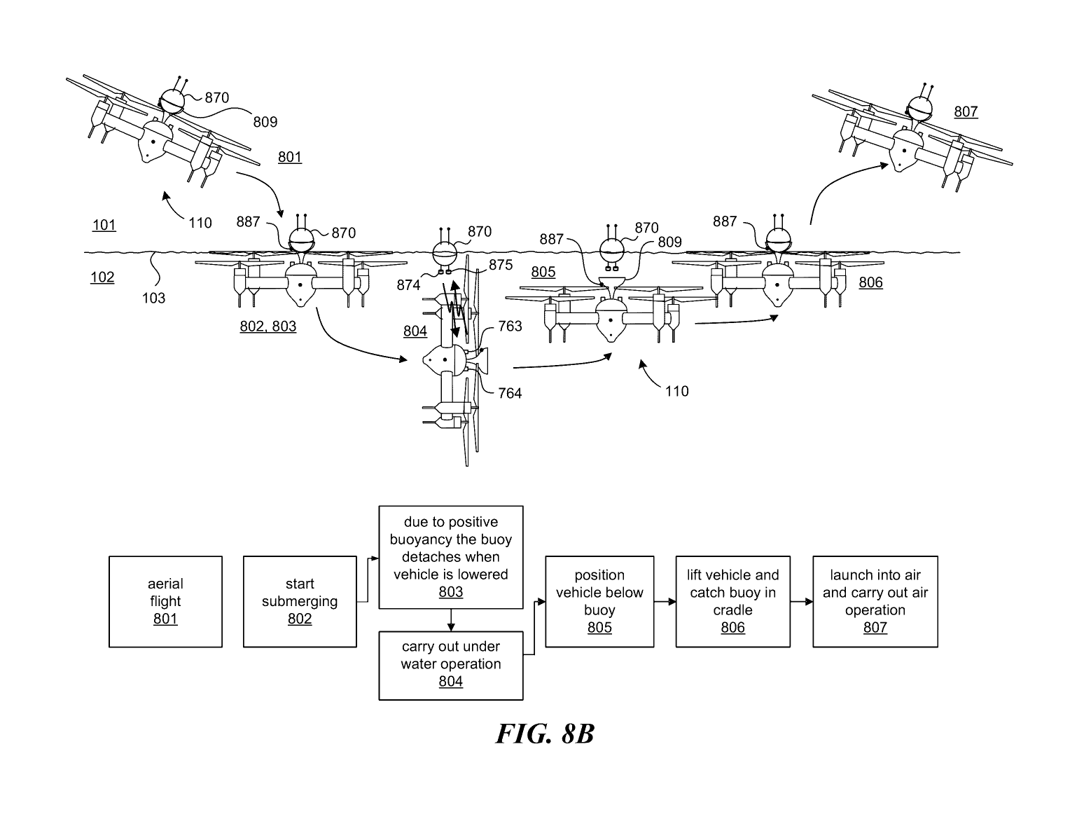

Because the UAV operator will typically be above the water, the overall system can include a relay or translator that translates radio frequency signals to hydroacoustic signals, and vice versa. For example, FIG. 8A illustrates a relay buoy 870 having a floating housing 877 that encloses electronic equipment configured to translate RF signals to hydroacoustic signals, and vice versa. Accordingly, the relay buoy 870 can include an aerial receiver antenna 871 that receives incoming RF signals 873b, e.g. from a remote user. The instructions received via the aerial receiver antenna 871 are then translated to hydroacoustic signals via a suitable translator circuit 886. The hydroacoustic signals are transmitted via an underwater transmitter antenna 874, in the form of an outgoing hydroacoustic signal 876a. In the opposite direction, an underwater receiver antenna 875 receives incoming hydroacoustic signals 876b from the submerged UAV which are then translated to RF signals and transmitted (e.g. to the user) as outgoing RF signals 873a via an aerial transmitter antenna 872. A low center of mass of the equipment within the buoy 870, alone or in combination with dischargeable ballast, can keep the buoy in an upright position.

In a particular embodiment, the relay buoy 870 can include a tether 878 that can eliminate the need for the underwater transmitter and receiver antennas 874, 875, described above, or provide backup for the underwater antennas 874, 875. In particular, the tether 878 can be connected to a submerged UAV to provide the incoming RF signals 873b directly to the UAV, and to receive from the UAV outgoing signals that are transmitted directly via the aerial transmitter antenna 871. The relay buoy 870 and/or the UAV can include a reel to prevent the tether 878 from interfering with the operation of either device.

An advantage of features of the relay buoy 870 is that they can reduce (e.g., minimize) the travel distance of signals in water. For example, the buoy can be positioned above the UAV and hence the travel distance in water is simply the depth of the vehicle—all the horizontal components of the full communication link are through air.

FIG. 8B is a partially schematic illustration of a process sequence (and associated flow diagram) for releasing and recapturing a buoy, for example, the buoy 870 described above with reference to FIG. 8A. Reference numerals 801-807 accordingly identify both the process portions in the flow diagram and the corresponding positions of the UAV.

Process portion 801 includes aerial fight, in which the UAV 110 carries the buoy 870, e.g. in a cradle 809. In process portion 802, the UAV 110 starts submerging and in process portion 803, the buoy detaches from the UAV 110 as the UAV 110 submerges. The buoy 870 remains floating after being detached. In a particular embodiment, the buoy 870 is snuggly, but releasably secured to the cradle 809 to prevent it from accidentally falling out during aerial maneuvers. For example, the cradle 809 can include an electrical, mechanical or electromechanical release mechanism 887 that is disengaged before the UAV 110 descends beneath the surface 103.

In process portion 804, the UAV 110 carries out its underwater operations and communicates with the buoy 870 at hydroacoustic frequencies via the corresponding antennas 763, 764, 874, 875. Alternatively, as discussed above, the UAV 110 can communicate with the buoy 870 via a tether 870a (FIG. 8A).

In process portion 805, the UAV 110 is positioned below the buoy 870 for ascent. In process portion 806, the UAV 110 ascends from beneath the buoy 870 to receive the buoy 870 in the cradle 809. If the cradle 809 includes the release mechanism 887, the release mechanism 887 secures the buoy 870 to the cradle 809. In process portion 807, the UAV 110 ascends from the surface 103 to carry out aerial operations, as discussed above.

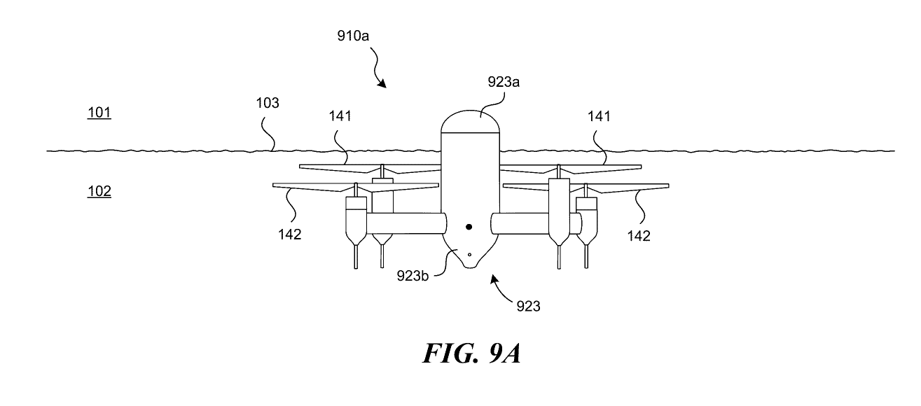

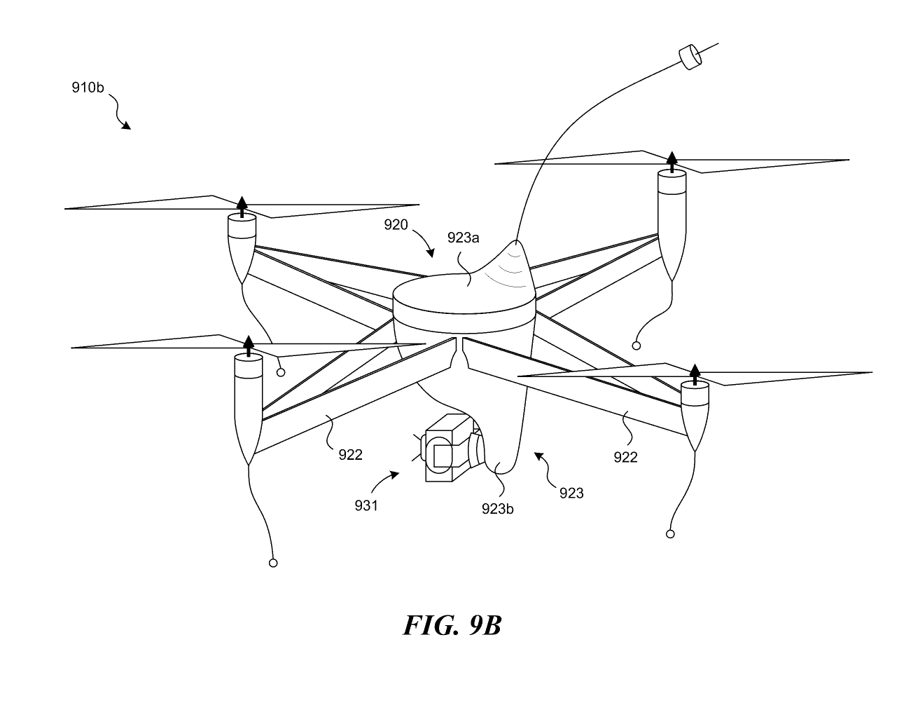

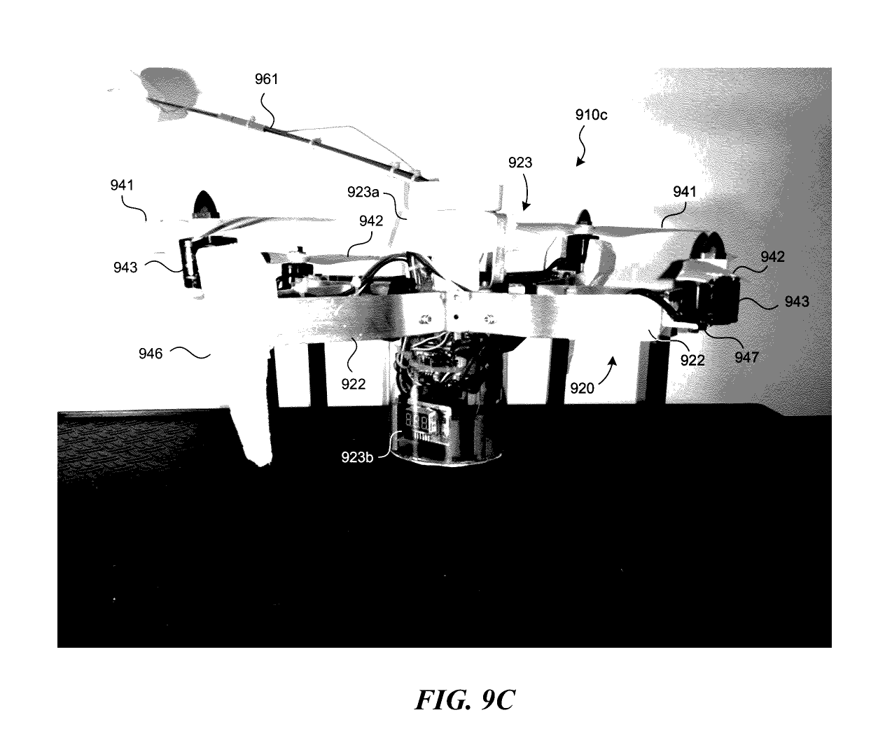

FIGS. 9A-9C illustrate submersible UAVs having configurations in accordance with further embodiments of the present disclosure. FIG. 9A illustrates a submersible UAV 910a having a fuselage 923 that is extended upwardly (when compared to the UAV 110 described above with reference to FIG. 2), so as to extend above the first and second propellers 141, 142. This embodiment can allow for better hydrodynamic performance and for simpler designs where the center of mass coincides exactly with the center of volume. Emerging and submerging procedures can be the same as for any of the preceding embodiments.

FIG. 9B illustrates a representative submersible UAV 910b configured in accordance with another embodiment of the present technology. The UAV 910b includes a support structure 920 that in turn includes a central fuselage 923 (with an upper portion 923a and a lower portion 923b), and boom portions 922. The lower portion 923b of the fuselage 923 can be tapered so as to accommodate an underwater camera with or without gimbal 931 positioned outside the fuselage 923. Accordingly, the camera 931 can be easily attached to, and removed from, the fuselage 923. The fuselage 923 can be formed from a suitable high-strength low weight material, such as fiberglass or a carbon composite. The boom portions 922 can have an open truss-type configuration, and can be manufactured from composites or a suitable corrosion-resistant metal (e.g., aluminum).

FIG. 9C is an isometric illustration of a representative demonstrator version of a submersible UAV 910c. As shown in FIG. 9C, the UAV 910c includes a plastic fuselage 923 having an upper portion 923a and a lower portion 923b. Boom portions 922 extend outwardly from the fuselage 923 and are formed from aluminum. Each boom portion 922 carries a motor 943 via a corresponding motor support. First motor supports 946 are longer than second motor supports 947 to elevate corresponding first propellers 941 above corresponding second propellers 942. An antenna 961 extends outwardly from the fuselage 923 to provide for RF communications with a user.

### Representative Controllers and Control Techniques

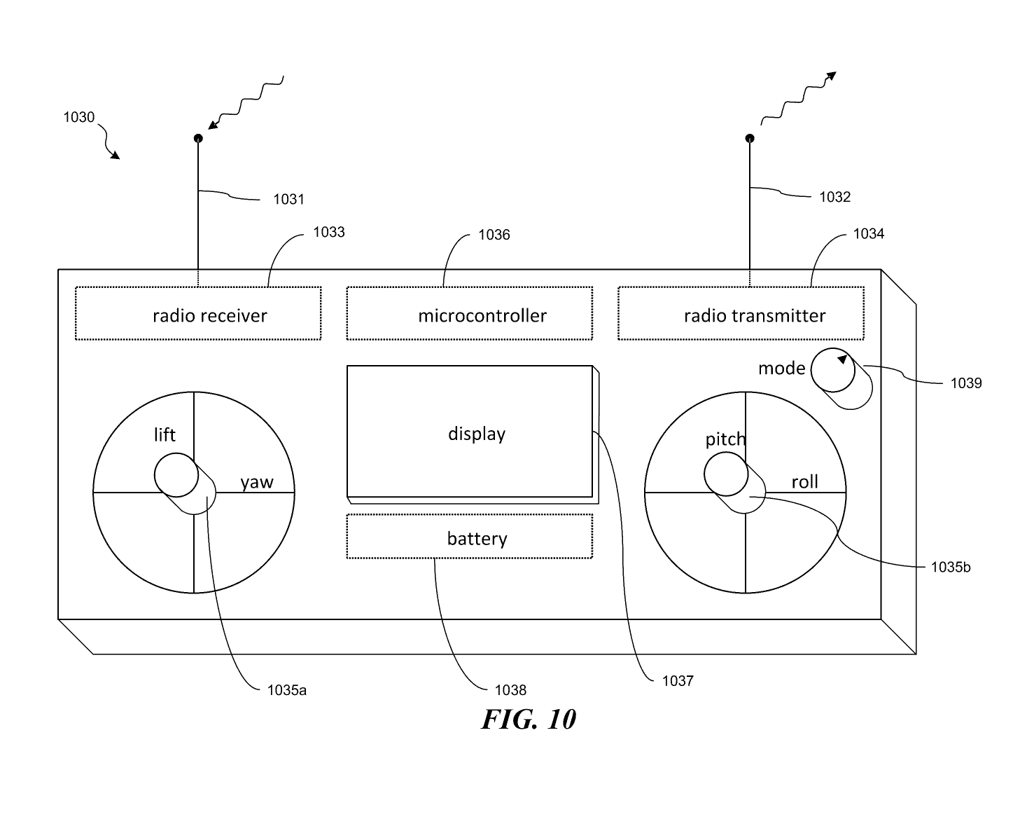

FIGS. 10-18 illustrate representative controllers and techniques for controlling the submersible UAV in the air and underwater. FIG. 10 illustrates a representative user controller 1030 (e.g., a ground station) that is operated by a user to control the UAV. The controller 1030 can include one or more sticks, joy sticks, or knobs 1035 illustrated as a first stick 1035a and a second stick 1035b. The first stick 1035a is manipulated to control lift via forward and aft movements, and yaw via left and right movements. The second stick 1035b is used to control pitch via forward and aft movements, and roll via left and right movements. The instructions received from the sticks 1035 are processed by a microcontroller 1036 that directs the instructions to a radio transmitter 1034 for communication to the UAV via a transmitter antenna 1032. For vehicles that include a feedback function, the controller 1030 can include a receiver 1033 and corresponding receiver antenna 1031 that receives information from the UAV. This information can also be processed by the microcontroller 1036 and presented at a display 1037, which can also present other information from the UAV, the controller 1030 and/or other sources. A battery 1038 or other power source supplies power for the operation of the user controller 1030.

The following sections describe how the UAV can be controlled in a rate mode. This mode is suitable for control in air and underwater. In this mode, the stick positions for yaw, pitch and roll set the respective rotation rate of the UAV around the respective axis. In general, UAVs may alternatively be controlled in an attitude mode. In this mode, the stick positions of yaw, pitch and roll set a specific orientation. While not discussed in further detail here, the user may switch to this mode with the mode select switch 1039.

The characteristics of the controls may change depending on whether the UAV is in air or underwater. This change may be automatically triggered by, for example, a water sensor, or set manually with another mode control switch. For example, one representative change can be that the center position of the lift stick may correspond to zero speed when the UAV is underwater and can correspond to the average motor speed needed for hover when the UAV is in air.

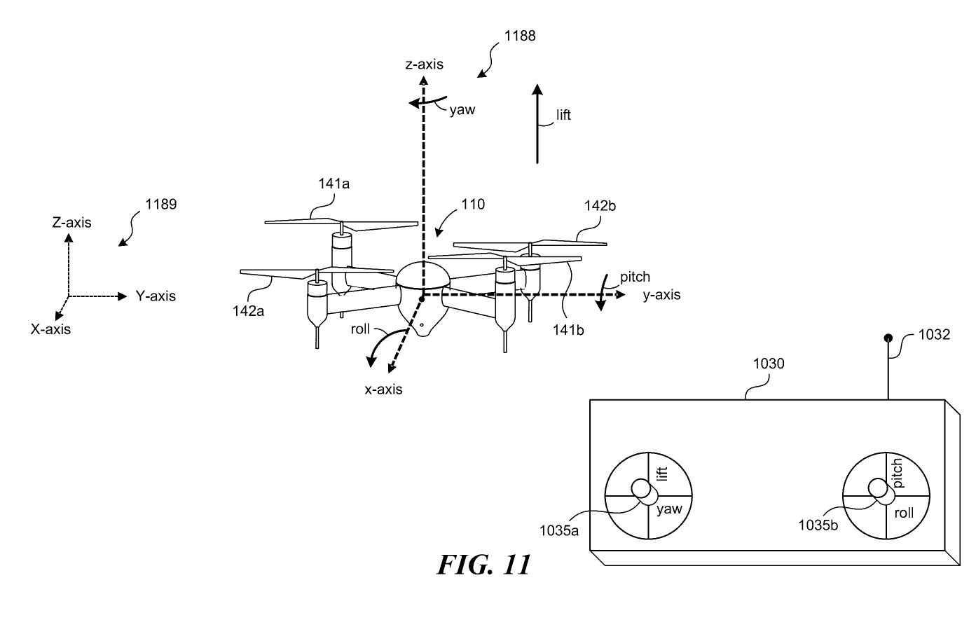

FIG. 11 illustrates the user controller 1030 in a controller coordinate system 1189, together with a representative submersible UAV 110 in its coordinate system 1188. x, y, and z denote the axes in the body frame of the UAV and X, Y, and Z denote the axes in the user frame, e.g., a laboratory frame. When the user directs lift, the UAV moves along the z axis, and when the user directs yaw, the UAV 110 rotates about the z axis. When the user directs pitch, the UAV rotates about the y axis, and when the user directs roll, the UAV 110 rotates about the x axis.

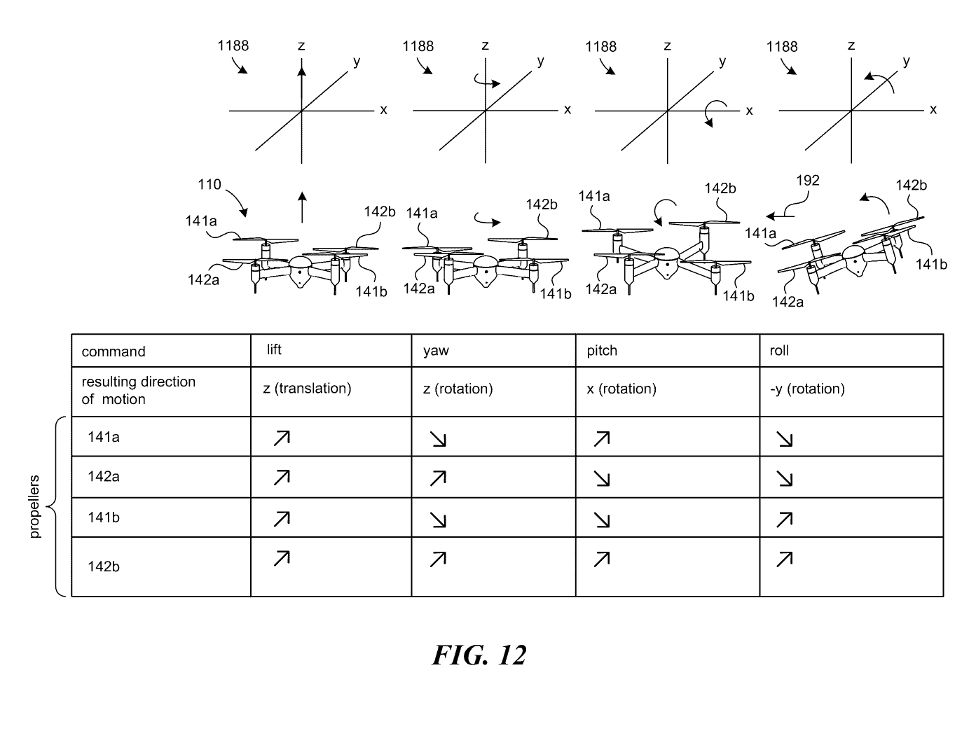

FIG. 12 illustrates the UAV 110 as it undergoes lift, yaw, pitch, and roll maneuvers. For purposes of illustration, FIG. 12 also illustrates the motion relative to the UAV coordinate system 1188. Still further, FIG. 12 includes a table identifying the relative thrust values provided by each of the four propellers to achieve the desired motion. For purposes of illustration, the first propellers 141 are identified as a left first propeller 141a and a right first propeller 141b. The second propellers 142 are illustrated as a left second propeller 142a and a right second propeller 142b. The arrows in the table indicate whether the thrust for the corresponding propeller increases or decreases.

During a lift maneuver, the UAV 110 translates along the z axis. To accomplish this maneuver, the thrust provided by all four propellers increases. To maintain a generally horizontal orientation, the thrust provided by each propeller is generally equal, or balanced.

The yaw maneuver shown in FIG. 12 corresponds to rotation of the UAV 110 about the z axis. To achieve this maneuver, the thrust provided by the oppositely-positioned second propellers 142a, 142b is higher than the thrust provided by the oppositely-positioned first propellers 141a, 141b. The thrust differential can be accomplished by increasing the thrust provided by the second propellers 142a, 142b and/or decreasing the thrust provided by the first propellers 141a, 141b.

To pitch the UAV 110 about the x axis, as shown in FIG. 12, the thrust provided by the distally-positioned left first propeller 141a and right second propeller 142b is higher than the thrust provided by the proximally-positioned left second propeller 142a and right first propeller 141b. The thrust differential can be accomplished by increasing the thrust provided by the left first propeller 141a and right second propeller 142b, and/or decreasing the thrust provided by the left second propeller 142a and right first propeller 141b.

To roll the UAV 110 about the y axis, the thrust provided by the right side propellers 141b, 142b is higher than the thrust provided by the left side propellers 141a, 142a. This can be accomplished by increasing the thrust provided by the right propellers 141b, 142b and/or decreasing the thrust provided by the left propellers 141a, 142a.

Each of the foregoing motions can be implemented by the UAV 110 whether it is operating in the air or underwater. Translational motion is accomplished as follows: In the air, the UAV 110 is translated along the X or Y laboratory axis by slightly rolling (pitching) the UAV 110. Underwater, the UAV 110 can only move effectively along its body axis z. Hence, to accomplish a motion along the X or Y laboratory axis, the UAV 110 can be fully rolled (pitched) such that the UAV's z axis aligns with the X or Y axis.

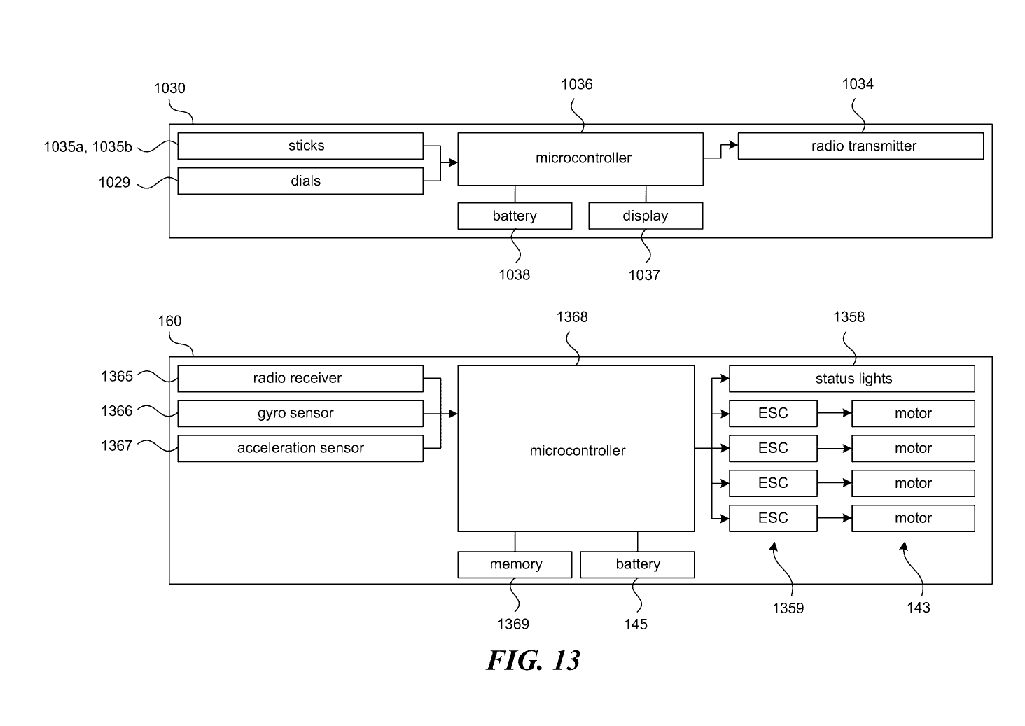

FIG. 13 is a schematic illustration of a representative user controller 1030, (e.g., a ground station) together with an on-board controller 160 (e.g., a flight/underwater motion controller). The representative embodiment shown in FIG. 13 corresponds to a relatively simple arrangement in which the user controller 1030 transmits signals to the UAV controller 160, but does not receive signals from the UAV. In addition, the communication with the UAV is via RF signals alone. Accordingly, the UAV under the control of the controllers 1030, 1060 remains in RF communication via a long, antenna of which the tip is floating (as discussed above with reference to FIG. 2) and/or a tether to a buoy (as discussed above with reference to FIG. 8A).

The user controller 1030 includes input devices, e.g., multiple sticks 1035a 1035b, and/or one or more dials 1029, a microcontroller 1036 that processes the inputs received from the input devices, and a radio transmitter 1034 that transmits signals resulting from the input devices. The battery 1038 provides power for the user controller 1030, and an optional display 1037 provides diagnostic information.

The vehicle controller 160 can include multiple sensors, e.g., a radio receiver 1365, a gyrosensor 1366, and an acceleration sensor 1367. The sensors provide inputs to a corresponding on-board microcontroller 1368 which provides instructions to a corresponding set of motor controllers 1359 (e.g., electronic speed controllers or ESCs) that in turn control the motors 143 described above with reference to FIG. 2. A battery 145, or other power source, provides power for the foregoing operations, and a memory 1369 stores information before, during and after the processing. Optional status lights 1358 can be used to provide a visual indication of the status of the UAV.

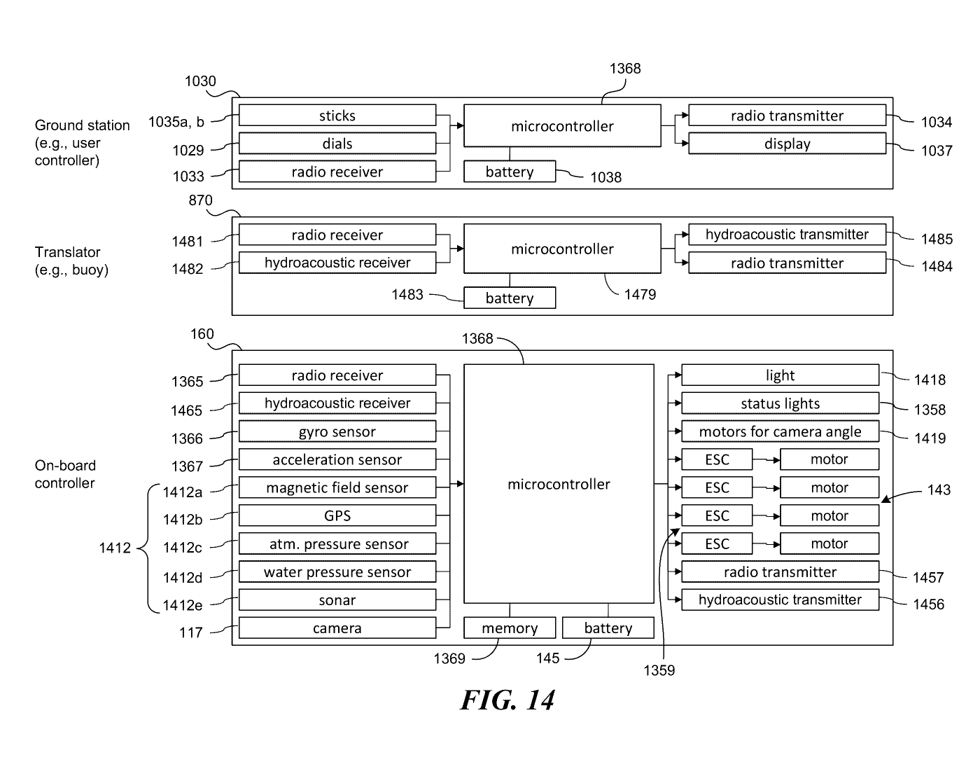

FIG. 14 is a schematic illustration of the user controller 1030 and the vehicle controller 160 described above with reference to FIG. 13, with additional components that support two-way communication between the UAV and the user, and underwater communication via hydroacoustic frequencies. Accordingly, the user controller 1030 can include, in addition to the components described above with reference to FIG. 13, a radio receiver 1033 that receives information from the UAV. A representative relay buoy or other translator 870 includes a radio receiver 1481 that receives radio signals from the user controller 1030, and a hydroacoustic receiver 1482 that receives signals from the underwater UAV. A microcontroller 1479 receives the inputs and provides relayed/translated outputs via a hydrocoustic transmitter 1485 and a radio transmitter 1484. Accordingly, signals received via the radio receiver 1481 are conveyed to the UAV via the hydroacoustic transmitter 1485. Signals received from the UAV via the hydroacoustic receiver 1482 are transmitted to the user controller 1030 via the radio transmitter 1484. A battery 1483 or other power source provides power for the foregoing operations.

The vehicle controller 160 can include further components in addition to those described above with reference to FIG. 13. On the input side of the microcontroller 1368, the controller 160 includes a hydroacoustic receiver 1465 that receives signals from the hydroacoustic transmitter 1485 carried by the relay buoy 870. The controller 160 can include multiple additional sensors 1412, including a magnetic field sensor 1412a, a GPS sensor 1412b, an atmospheric pressure sensor 1412c, a water pressure sensor 1412d, and a sonar sensor 1412e. Inputs from the receivers and sensors are provided to the microcontroller 1368 which, in addition to providing instructions for the motors 143, can provide instructions to a radio transmitter 1457 that communicates directly with the ground controller 1030, and a hydroacoustic transmitter 1456 that communicates with the user controller 1030 via the relay buoy 870. The microcontroller 1368 can also provide instructions for lights 1418 (e.g., for operation in dark, underwater environments) and an output for a camera motor 1419 (e.g., to control the on-board camera) and/or other outputs.

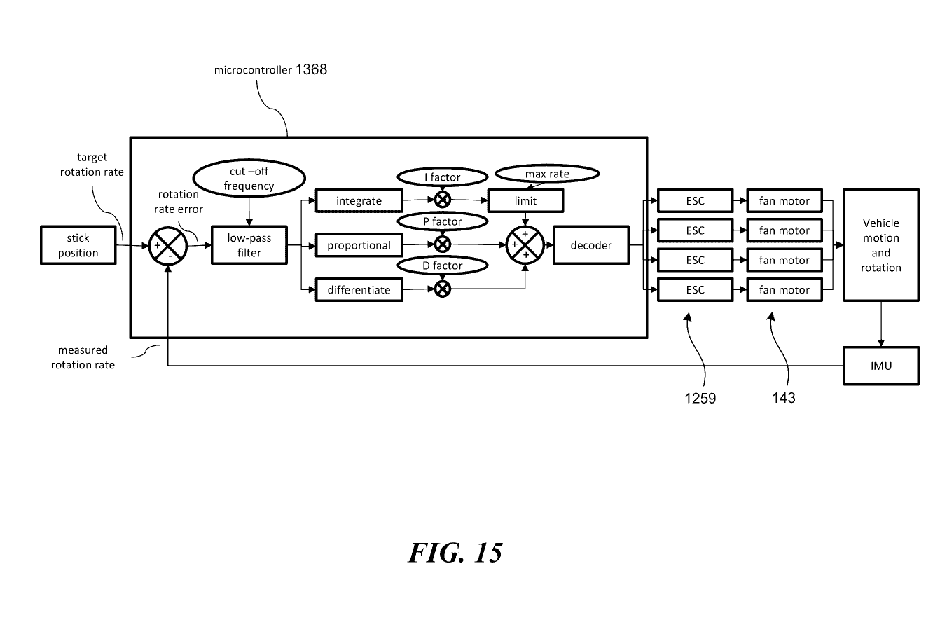

FIG. 15 is a partially schematic illustration of a representative single-axis control loop for controlling pitch, yaw or roll of the UAV. The position of the stick at the user controller represents a target rotation rate for the UAV. The actual rotation rate may be measured by an IMU (inertial measurement unit), in particular, a gyroscope in the IMU. The microcontroller 1368 can calculate a rotation rate error by subtracting the measured rotation rate from the target rotation rate. The error may be filtered (e.g., low-pass filtered) with a cut-off frequency of about 50 Hz in a particular embodiment. The error can then be integrated, passed directly through, and differentiated. Each term may then be multiplied by a corresponding factor (e.g., an i-factor, p-factor and d-factor). The factors may be determined following the Ziegler-Nichols method and/or other suitable methods. In particular embodiments, the factors can differ depending on whether the vehicle is located in the air or in water, and can switch between aerial values and submerged values based on sensor data received from sensors on board the UAV. In a further particular aspect of an embodiment shown in FIG. 15, the integrator term is limited to a maximum rate, each of the three terms are then added, and a decoder determines the change in speed for each of the motors 143 via corresponding electronic speed controllers (ESC) 1259.

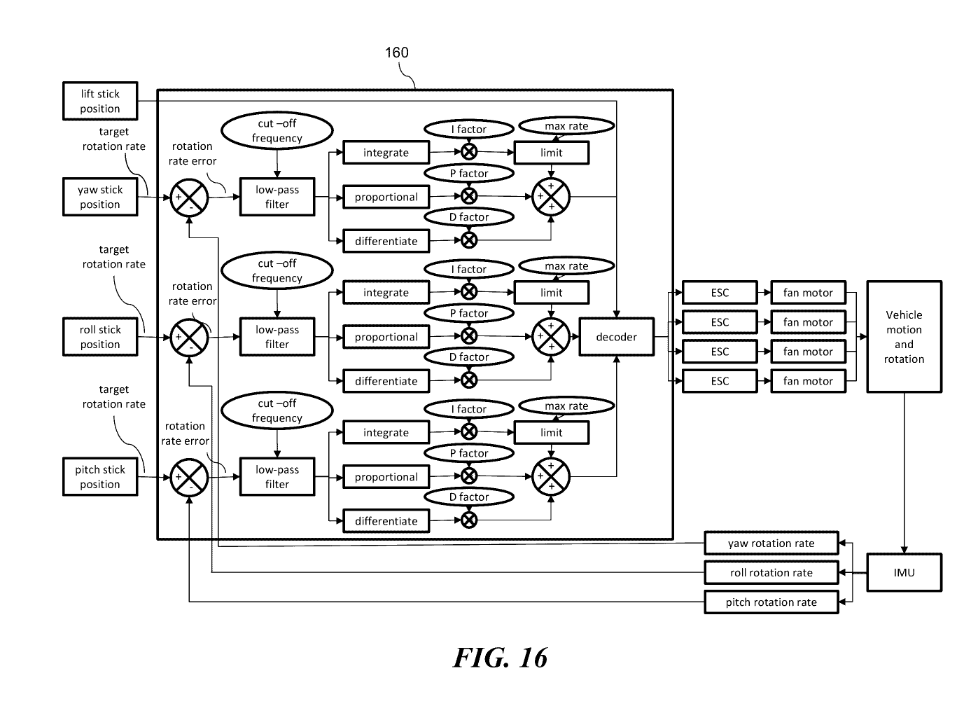

FIG. 16 schematically illustrates the on-board vehicle controller 160 having a control loop arrangement for rotation about each of the x, y and z axes. In this embodiment, translation along the lift axis does not include a feedback loop, as the UAV is typically inherently stable in this degree of freedom. In other embodiments, the vehicle may not be stable for motion along the z-axis, and can accordingly include an additional feedback loop. Such a feedback loop can use air pressure sensor data in air and/or flow velocity data under water as an input.

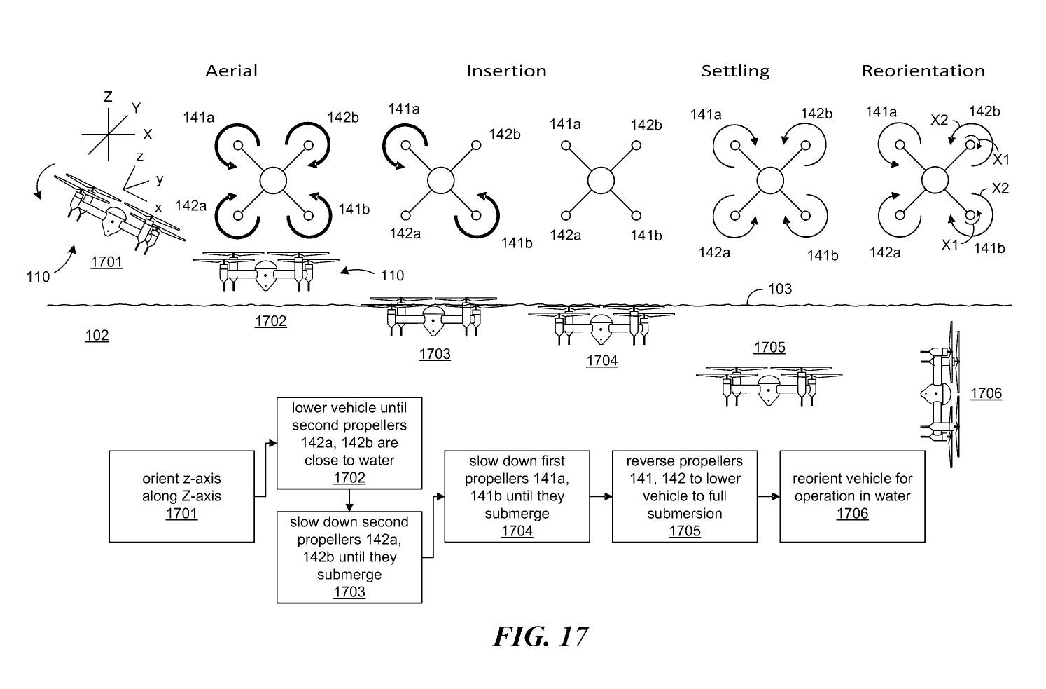

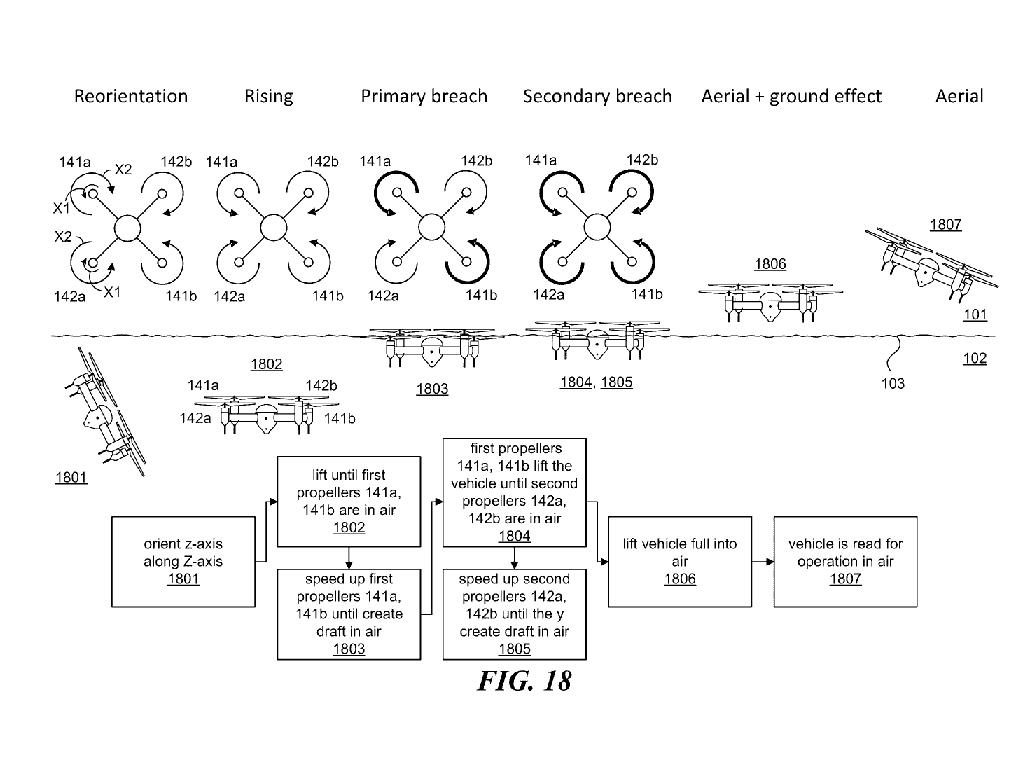

FIGS. 17 and 18 schematically illustrate (a) the submersible UAV 110 as seen from the side, together with (b) a schematic illustration of the UAV from above, illustrating the magnitude and direction of the propeller rotation, and (c) a flow diagram of the processes for submerging the UAV 110 (FIG. 17) and surfacing the UAV 110 (FIG. 18). Beginning with FIG. 17, in process portion 1701, the z axis of the UAV is oriented along the Z axis of the user, typically placing the UAV in a horizontal orientation. At process portion 1702, the UAV is lowered by decreasing the thrust to the first propellers 141a, 141b and the second propellers 142a, 142b until the second propellers (e.g., the lower propellers 142a, 142b) are close to the water. Then, as shown in process portion 1703, the speed of the second propellers 142a, 142b is further decreased and then stopped as they submerge. In process portion 1704, the rotation speed of the first propellers 141a, 141b (which still project from the surface 103 of the water 102) is decreased and then stopped as the first propellers 141a, 141b submerge. With all the propellers submerged, process portion 1705 includes reversing the rotation direction of the propellers to further submerge the entire UAV 110. In process portion 1706, the UAV is reoriented for operation in the water. To reorient the vehicle so that it is facing toward the right, as shown in FIG. 17, the thrust of the left first and second propellers 141a, 142a can be increased relative to that of the right first and second propellers 141b, 142b. Arrows X1 indicate the reduced rotational velocity of the right propellers 141b, 142b relative to the left propellers 141a, 142a. In another embodiment, the rotation direction of the right side propellers 141b, 142b can be reversed, as indicated by arrows X2. Reversing the rotation direction can more quickly reorient the vehicle to face the direction shown in FIG. 17.

Referring next to FIG. 18 (which illustrates the opposite sequence of events for surfacing the UAV 110) process portion 1801 includes reorienting the vehicle's z axis with the user's Z axis. In this case, the right side propellers 141b, 142b can have a higher rotational velocity than the left propellers 141a, 142a, as indicated by the smaller arrows x1. As discussed above with reference to FIG. 17, this maneuver can be sped up by reversing the rotation direction of the left side propellers 141a, 142a, as indicated by arrows x2. This operation, described in the context of a submersible maneuver, can also be used while the vehicle is in the air. It is expected that this approach will provide significantly more agile performance (e.g., in the form of “snap” turns) than simply changing the relative speeds of the right and left side propellers without changing the rotational direction. Accordingly, the ability to reverse the rotation direction of the propellers can have advantageous applications for both submersible and non-submersible UAVs.

In process portion 1802, each of the propellers 141a, 142a, 141b, 142b are rotated at the same rate to lift the UAV 110 to the surface. After the first propellers 141a, 141b emerge from the surface, their rotation rate can be increased so as to create lift (process portion 1803). In process portion 1804, the first propellers 141a, 141b lift the UAV 110 (optionally with the assistance of the underwater second propellers 142a, 142b) until the second propellers 142a, 142b emerge from the surface 103. At that point (process portion 1805) the rotation rate of the second propellers 142a, 142b is increased until they, too, provide aerial lift. In process portion 1806, the vehicle is lifted into the air and in process portion 1807, the vehicle lifts further away from the surface 103 for further aerial operation.

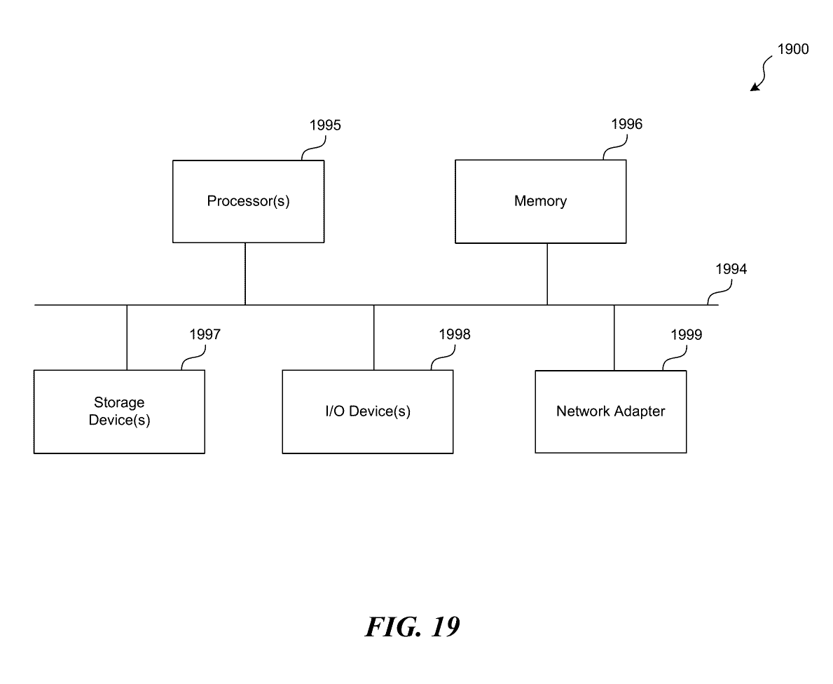

FIG. 19 is a block diagram of a computer system 1900 suitable for implementing features of the embodiments. The computing system 1900 can include one or more central processing units (“processors”) 1995, memory 1996, input/output devices 1998 (e.g., keyboard and pointing devices, display devices), storage devices 1997 (e.g., disk drives), and network adapters 1999 (e.g., network interfaces) that are connected to an interconnect 1994. The interconnect 1994 represents any of one or more separate physical buses, point to point connections, or both connected by appropriate bridges, adapters, or controllers. The interconnect 1994, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 1996 and storage devices 1997 are computer-readable storage media that can store instructions that implement at least portions of the various embodiments. In addition, the data structures and message structures may be stored or transmitted via a data transmission medium, e.g., a signal on a communications link. Various communications links may be used, e.g., the Internet, a local area network, a wide area network, or a point-to-point dial-up connection. Thus, computer readable media can include computer-readable storage media (e.g., “non transitory” media) and computer-readable transmission media.

The instructions stored in memory 1996 can be implemented as software and/or firmware to program the processor(s) 1995 to carry out actions described above. In some embodiments, such software or firmware may be initially provided to the processor(s) 1995 by downloading it from a remote system through the computer system 1900 (e.g., via network adapter 1999).

The various embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

Several of the embodiments described above include features that can result in significant advantages when compared to existing systems. For example, several embodiments of the submersible UAVs described above are configured to transition seamlessly between water and air without any human intervention needed and without limitation on the number of transitions. Several of these embodiments include a relatively small number of moving parts, making the UAVs cheaper and easier to manufacture and maintain. This arrangement can also make UAVs simpler to operate. In particular embodiments, the number of moving parts of the UAV can correspond directly to the number of degrees of freedom of motion that the UAV is capable of. For example, the UAV can include four propeller shafts, each carrying a fixed propeller, which allow for four degrees of freedom (motion along the z axis, and rotation about the x, y and z axes).

The amount of human intervention required to operate UAVs in accordance with many of the embodiments described above can be significantly reduced when compared to conventional UAVs. For example, embodiments of the foregoing UAVs can be seamlessly transitioned from underwater operation to aerial operation, repeatedly, without human intervention.

The weight of the submersible UAV can be significantly less than for other submersible vehicles because the same propulsion system and in particular, the same propellers are used both for aerial operation and for underwater operation. The submersible UAV may be controlled in any of a number of suitable manners, including via remote control, via semiautonomous operation, and/or via autonomous operation. The UAV can be controlled remotely via a radio frequency link, or can be pre-programmed with GPS waypoints or with a route that is followed via inertial navigation. An inertial measurement unit can be used for both aerial and underwater navigation. The submersible nature of the UAV, in addition to allowing the UAV to perform normal operations underwater, can significantly improve the weather resistance of the UAV when performing aerial operations.

Embodiments of the submersible UAV described above can be used in a wide variety of contexts. For example, the UAVs can be used to investigate both land and underwater phenomena for scientific purposes. In other embodiments, the submersible UAV can be used to search for airplane crash locations over disparate ocean locations, perform ship inspections both above and below the waterline, inspect electrical transmission towers or bridges both above and below the waterline, provide fast access to a drowning victim (and can optionally include an inflatable device as a payload), collect and (optionally) analyze water samples at a variety of depths and/or laterally spaced locations, replace more complex and expensive submarines for providing a wide variety of tasks, provide cinematography and photography that is seamless in transition from air to water, permit research on amphibious animals, including animals traveling long distances underwater, cave exploration, fish location, telecommunication infrastructure inspection, transportation, among others, including any activities that require access to liquid environments not easily accessed by humans.

From the foregoing, it will be appreciated that specific embodiments of the present technology have been described herein for purposes of illustration, but that various modifications may be made without deviating from the disclosed technology. For example, in some embodiments, the submersible UAV can be completely reliant on an on-board battery. In other embodiments, the submersible UAV can absorb solar energy, wave power, and/or obtain power via other avenues while at the surface. In addition, the submersible UAV can perform useful operations while on the surface, for example, monitoring surface conditions. In some embodiments, e.g., to conserve power, the submersible UAV can drift with the current to transit from one point to another.

In several embodiments, the liquid into which the submersible UAV submerges is water, for example, in a river, lake, sea, or ocean. In other embodiments, the submersible UAV can perform in other liquid environments, for example, in industrial liquids or, if used for planetary research, in non-aqueous liquid bodies on other planets. The UAV may also operate in air in a zero-gravity environment (e.g., the environment within a space capsule or aircraft undergoing a zero-gravity maneuver) following the same control logic as underwater. Several embodiments were described above in the context of a four-rotor quadcopter configuration. In other embodiments, the submersible UAV can include other numbers of propellers (e.g., six or eight propellers, or 3 or 2 when adding features like pivotable arms or pitch adjustable propellers). In such cases, the propellers can be positioned in more than two stacked planes. In a further particular embodiment, additional propellers can be used to reduce or prevent yawing motion that may occur if the first propellers provide more thrust than the second propellers during submersion or emersion.

In several of the embodiments described above, the propeller rotation axes are generally parallel to the vehicle axis. In other embodiments, the propeller axes may be canted, inwardly or outwardly. When the propellers are offset along the vehicle axis, propellers at different offset distances may be located in similar but offset, non-planar surfaces, as a result of the cant. Such a surface can include a conical surface or a spherical surface.

Several embodiments were described above in the context of propulsion systems that include propellers. In other embodiments, the propulsion system can include rockets (with an on-board oxidant source) for operation both in air and in water.

Particular embodiments were described in the context of a payload that includes a camera. In other embodiments, the payload can include other devices, for example, a rescue flotation device, as described above. Such devices can include a laser scanner, stereoscopic or 3-D cameras, a spectrometer, lidar, chemical analyzer, and/or refractometer, among others. In still further embodiments, the payload can include cargo that is transported from one place to another. The cargo payload can be automatically attached and/or detached. The cargo can be human or non-human. When the cargo is human, the vehicle can remain an unmanned vehicle, or in other embodiments, the techniques described above can be applied to manned vehicles.

In several embodiments described above, the general control logic for operating the vehicle in the air and underwater is the same. In other embodiments, the control logic can be changed, for example, by choosing attitude mode in air and controlling direct motion along the laboratory Z, X, and Y axes instead of controlling lift, pitch and roll underwater. An advantage associated with relatively small changes is that it reduces the complexity of the overall system. Several embodiments need not include a buoyancy control system, and other embodiments can include a buoyancy control system, e.g., not only to submerge and emerge, but to account for buoyancy changes over the entire depth profile of the UAV. In particular embodiments, the UAV can submerge to depths of 50 meters, and in other embodiments, can submerge to other depths. In still further embodiments, embodiments of the submersible UAV can provide video for snorkelers or scuba divers or other water sports athletes both above and below the water. Embodiments of the submersible UAVs can be used as toys in yet further embodiments.

Certain aspects of the technology described in the context of particular embodiments may be combined or eliminated in other embodiments. For example, the control logic and motor arrangement used to reverse propeller rotation for a submersible UAV can, in other embodiments, be applied to a non-submersible UAV to provide for rapid maneuvers. Further, while advantages associated with certain embodiments of the technology have been described in the context of those embodiments, other embodiments may also exhibit such advantages, and not all embodiments need necessarily exhibit such advantages to fall within the scope of the present technology.

Reference in the present specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited in some embodiments and not others. Similarly, various requirements are described which may be requirements for some embodiments but not for others.

To the extent any of the materials incorporated herein by reference conflict with the present disclosure, the present disclosure controls.

I claim:

1. A submersible unmanned aerial vehicle (UAV), comprising:
support structure;
a power source carried by the support structure;
a plurality of propellers carried by the support structure and coupled to the power source, wherein the plurality of propellers includes a plurality of first laterally spaced-apart propellers spaced apart from a plurality of second laterally spaced-apart propellers along an axis extending away from the support structure; and
a controller carried by the support structure and having instructions for directing the vehicle in the air and underwater.

2. The submersible UAV of claim 1 wherein individual first propellers are carried by corresponding first propeller shafts, and wherein individual second propellers are carried by corresponding second propeller shafts, and wherein the first and second propeller shafts have fixed positions relative to each other.

3. The submersible UAV of claim 1 wherein the individual first propellers and individual second propellers have a fixed pitch.

4. The submersible UAV of claim 1 wherein the individual first propellers and individual second propellers have a variable pitch.

5. The submersible UAV of claim 1 wherein the plurality of first propellers includes two first propellers in a first surface, and wherein the plurality of second propellers includes two second propellers in second surface spaced apart from the first surface.

6. The submersible UAV of claim 5 wherein the first and second surfaces are flat.

7. The submersible UAV of claim 1 wherein the water-tight, submersible aerial flight support structure, the power source, the plurality of propellers and the controller together are neutrally buoyant in water.

8. The submersible UAV of claim 1 wherein the water-tight, submersible aerial flight support structure, the power source, the plurality of propellers and the controller together are positively buoyant in water.

9. The submersible UAV of claim 1 wherein each of the first and second propellers are offset from a propwash footprint of the others.

10. The submersible UAV of claim 1, further comprising a payload.

11. The submersible UAV of claim 10 wherein the payload includes a camera.

12. The submersible UAV of claim 10 wherein the payload includes a sensor.

13. A submersible unmanned aerial vehicle (UAV), comprising:
a support structure;
a power source carried by the support structure; and
a plurality of propellers carried by the support structure and coupled to the power source, wherein the plurality of propellers includes a plurality of first laterally spaced-apart propellers positioned above a plurality of second laterally spaced-apart propellers along an axis extending upwardly away from the support structure.

14. The submersible UAV of claim 13 wherein the power source includes at least one battery coupled to a motor.

15. The submersible UAV of claim 14 wherein the motor includes a variable speed induction motor.

16. A method for operating a submersible unmanned aerial vehicle (UAV), comprising:
directing the submersible UAV on an aerial flight path, the submersible UAV having a plurality of propellers rotatable about corresponding rotation axes, the rotation axes extending generally upwardly;
landing the submersible UAV in water;
directing the submersible UAV to submerge;
rotating the submersible UAV so that the rotation axes extend generally transversely; and
directing the submersible UAV along a generally transverse underwater path with the rotation axes extending transversely.

17. The method of claim 16, further comprising:
after directing the submersible UAV along a generally transverse underwater path:
directing the submersible UAV to the water's surface; and
directing the submersible UAV into aerial flight from the water's surface.

18. The method of claim 16 wherein the plurality of propellers includes a plurality of first propellers positioned above a plurality second propellers when the submersible UAV is in aerial flight, and wherein the method further comprises:
after directing the submersible UAV along a generally transverse underwater path:
extending the first propellers out of the water;
while the first propellers extend out of the water and the second propellers are in the water, lifting the submersible UAV toward aerial flight, with lift provided by the first propellers acting on air and the second propellers acting on the water.

19. The method of claim 16 wherein directing the submersible UAV on an aerial flight path includes rotating the plurality of propellers at a first rate, and wherein directing the submersible UAV along a generally transverse underwater path includes rotating the plurality of propellers at a second rate less than the first rate.

20. The method of claim 16 wherein directing the submersible UAV on an aerial flight path includes rotating at least one of the propellers in a first direction, and wherein directing the submersible UAV to submerge includes rotating the at least one propeller in a second direction opposite the first direction.

21. The method of claim 16 wherein directing the submersible UAV on an aerial flight path includes directing the submersible UAV to turn by rotating at least one of propellers in a first direction and rotating at least another one of the propellers in a second direction opposite the first direction.
